(19) United States
(12) Patent Application Publication
(10) Pub. No.: US 2020/0227218 A1
(43) Pub. Date: Jul. 16, 2020

(54) Electrical equipment and additional functional module associated therewith

(71) Applicant: BERKER GmbH & Co. KG, SCHALKSMOHLE (DE)

(72) Inventors: Jacques KRAEMER, STRASBOURG (FR); Pascal NOEL, WIWERSHEIM (FR)

(21) Appl. No.: 16/629,243

(22) PCT Filed: Jul. 10, 2017
(86) PCT No.: PCT/EP2017/067258

§ 371 Date: Jan. 7, 2020

(51) Int. Cl. H01H 21/04; H02G 3/14; H01H 1/58

(52) U.S. Cl. CPC H01H 21/04; H01H 2300/03; H01H 1/5866; H02G 3/14

(57) ABSTRACT

An electrical equipment (1) for an electrical installation is connected to an electrical grid, and has at least: —a primary functional module (2) suitable for carrying out a current interruption function, —and an additional functional module (5) for carrying out at least one function requiring a power supply. The at least one function of the additional functional module (5) is a function of shaping the physical parameters of an electrical signal originating from the first line (L) of the electrical grid.

The present invention relates to an electrical apparatus for an electrical installation, to an additional functional module for this electrical apparatus, and to an electrical installation.

Document DE 19 21 571 A1 describes an electrical switch comprising a lighting element connected to the electrical circuit of the electrical switch in order to perform an indicator light or permanent lighting function. Such an electrical switch only makes it possible to perform an indicator light or permanent lighting function. This electrical switch therefore does not make it possible to implement more sophisticated functionalities, and is therefore limited.

The present invention aims to propose a flexible and customizable solution for an electrical apparatus and to overcome the drawbacks of the prior art.

The present invention relates to an electrical apparatus for an electrical installation, able and intended to be connected to an electrical grid, comprising at least:
a primary functional module comprising a first connection pole able and intended to be connected to a first line of the electrical grid and a second connection pole able and intended to be connected to a second line of an electrical circuit of the electrical installation and, where applicable, a third connection pole able and intended to be connected to a third neutral line of the electrical grid,

the primary functional module being able and intended to perform a function of interrupting the current between the first connection pole and the second connection pole and comprises a control member such that, in an open position, an electrical circuit between the first connection pole and the second connection pole is open and that, in a closed position, the electrical circuit is closed,
an additional functional module comprising means for performing at least one function requiring an electric power supply, comprising at least a fourth connection pole and a fifth connection pole that are electrically connected respectively to the first connection pole and to the second connection pole or, where applicable, to the third connection pole of the primary functional module in order to supply power to the additional functional module and, where applicable, the additional functional module comprises a sixth connection pole electrically connected to the second connection pole of the primary functional module,
a reception module comprising at least a first reception area for receiving the primary functional module,

which electrical apparatus is characterized in that the reception module comprises a second reception area for receiving the additional functional module,

and in that said at least one function of the additional functional module is a function of shaping the physical parameters of an electrical signal coming from the first line of the electrical grid.

The invention also relates to an additional functional module for an electrical apparatus as described above, said electrical apparatus comprising a primary functional module and an additional functional module, said additional functional module being characterized in that it corresponds to the additional functional module of said electrical apparatus and comprises at least a fourth connection pole and a fifth connection pole that are able and intended to be electrically connected respectively to the first connection pole and to the second connection pole or, where applicable, to the third connection pole of the primary functional module of the electrical apparatus, in order to supply power to the additional functional module and, where applicable, the additional functional module comprises a sixth connection pole able and intended to be electrically connected to the second connection pole of the primary functional module, and comprises means for performing at least one function requiring an electric power supply, and in that said at least one function of the additional functional module is a function of shaping the physical parameters of an electrical signal coming from the first line of the electrical grid.

The invention also relates to an electrical installation able and intended to be connected to the electrical grid comprising at least one load, characterized in that it comprises at least one electrical apparatus as described above.

The invention will be better understood by virtue of the following description, which relates to several preferred embodiments that are given by way of non-limiting example and explained with reference to the appended schematic drawings, in which:

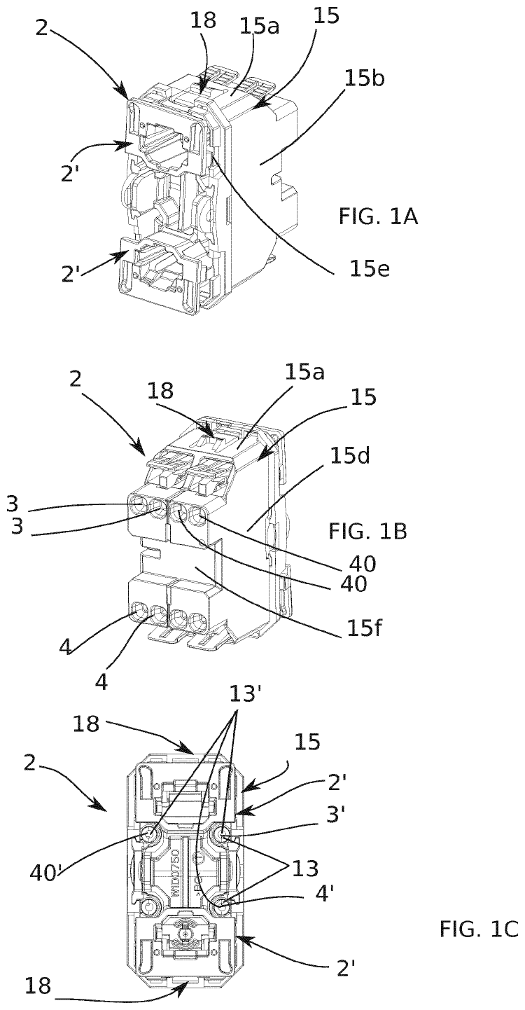

FIG. 1A is a perspective plan view of a primary functional module according to the invention,

FIG. 1B is a perspective bottom view of the primary functional module shown in FIG. 1A,

FIG. 1C is a plan view of the primary functional module shown in FIG. 1A,

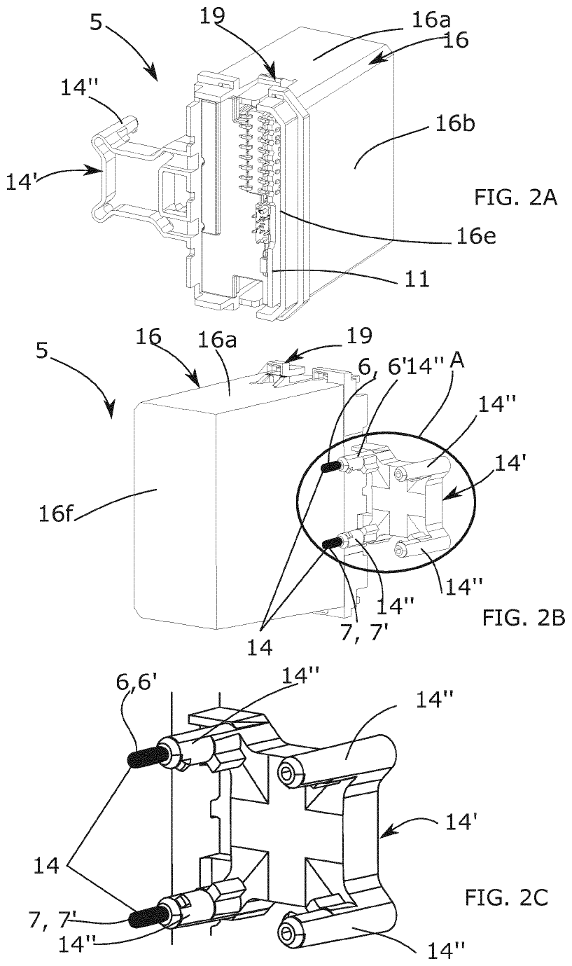

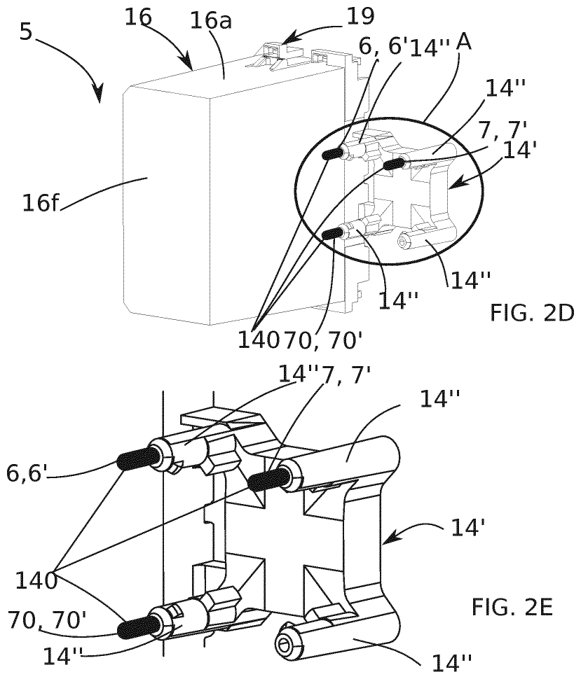

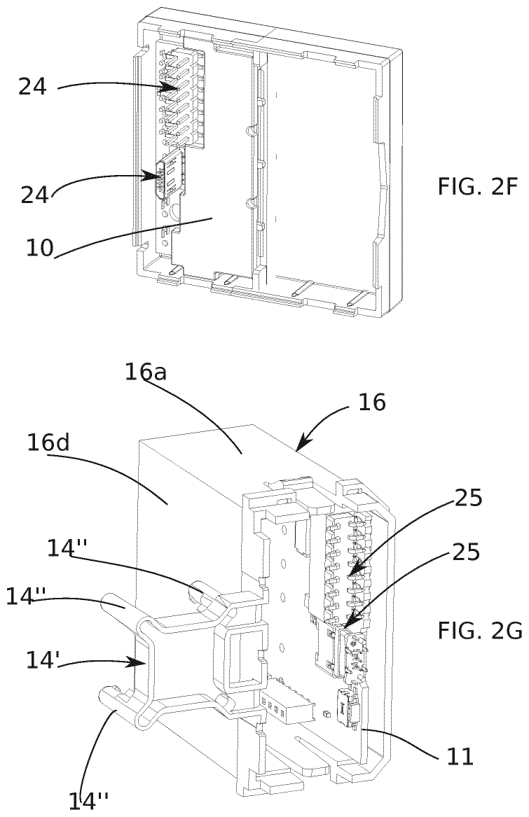

FIG. 2A is a perspective plan view of an additional functional module according to the invention,

FIG. 2B is a perspective bottom view of the additional functional module shown in FIG. 2A in a variant embodiment of the invention,

FIG. 2C is a perspective view of the detail A shown in FIG. 2B,

FIG. 2D is a perspective bottom view of the additional functional module in another variant embodiment of the invention,

FIG. 2E is a perspective view of the detail A shown in FIG. 2D,

FIG. 2F is a perspective view of a removable electronic card of the additional functional module,

FIG. 2G is a perspective view of the functional module without the removable electronic card,

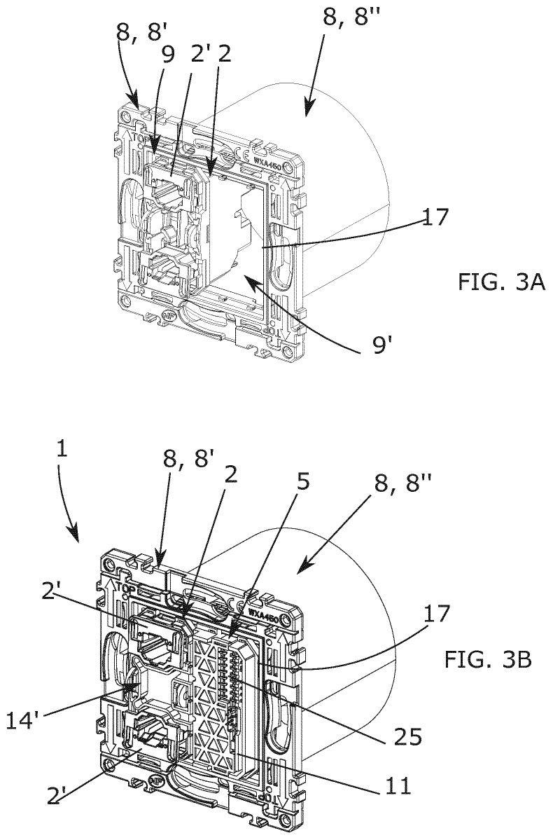

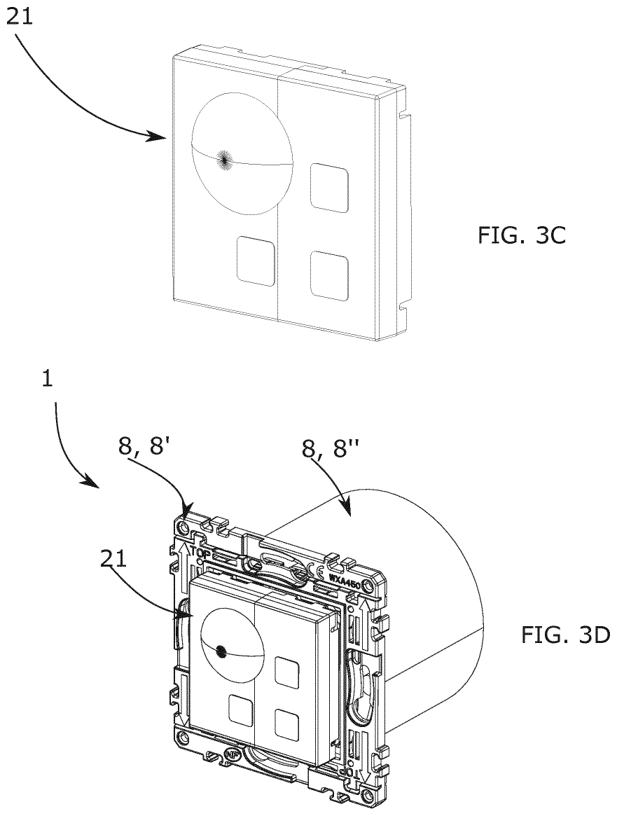

FIG. 3A is a perspective view of the primary functional module according to the invention shown in FIGS. 1A to 1C associated with a support frame of the reception module,

FIG. 3B is a perspective view of the electrical apparatus according to the invention comprising the primary functional module according to the invention shown in FIGS. 1A to 1C and the additional functional module shown in FIGS. 2A to 2G,

FIG. 3C is a perspective view of a cover plate according to the invention,

FIG. 3D is a perspective view of the electrical apparatus shown in FIG. 3B and provided with a cover plate shown in FIG. 3C,

FIG. 4 is a view of the electrical apparatus according to the invention,

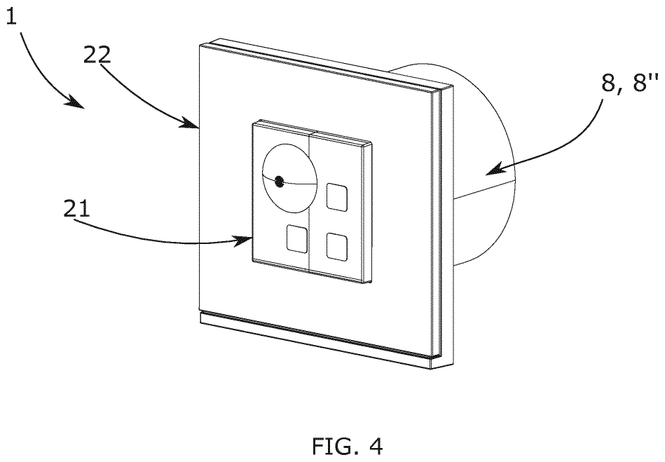

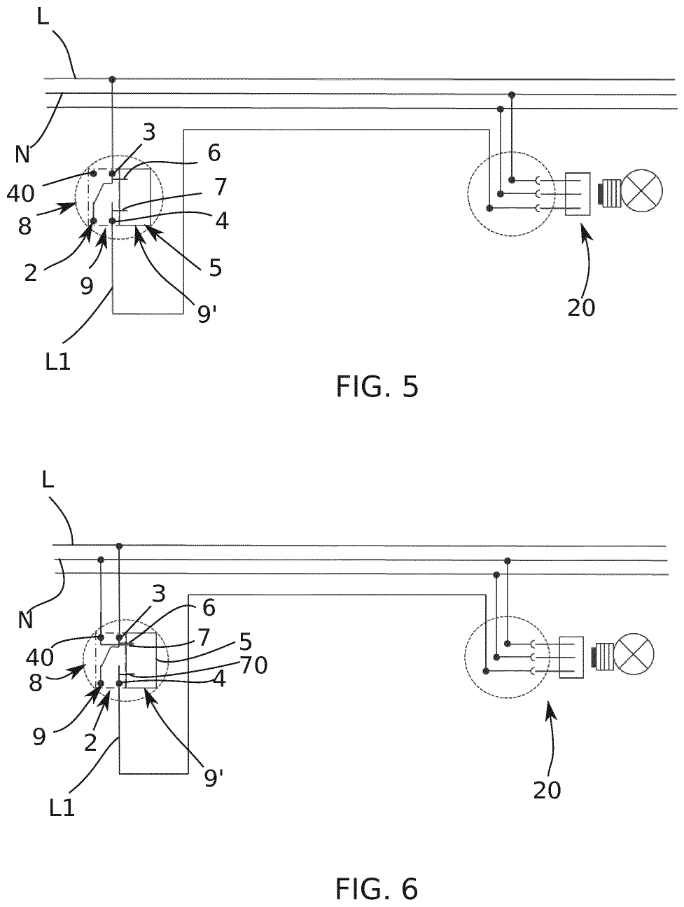

FIG. 5 is a view of a circuit diagram showing the electrical apparatus according to a variant embodiment of the invention installed in an electrical installation, and

FIG. 6 is a view of a circuit diagram showing the electrical apparatus according to a variant alternative embodiment of the invention installed in an electrical installation.

The electrical apparatus 1 for an electrical installation (FIGS. 5 and 6), able and intended to be connected to an electrical grid, comprises at least:
a primary functional module 2 comprising a first connection pole 3 able and intended to be connected to a first line L of the electrical grid and a second connection pole 4 able and intended to be connected to a second line L1 of an electrical circuit of the electrical installation and, where applicable, a third connection pole 40 able and intended to be connected to a third neutral line N of the electrical grid (FIG. 1B),
the primary functional module 2 (FIGS. 1A and 1C) being able and intended to perform a function of interrupting the current between the first connection pole 3 and the second connection pole 4 and comprises a control member 2′ such that, in an open position, an electrical circuit between the first connection pole 3 and the second connection pole 4 is open (FIGS. 5 and 6) and that, in a closed position, the electrical circuit is closed,
an additional functional module 5 comprising means for performing at least one function requiring an electric power supply, comprising at least a fourth connection pole 6 and a fifth connection pole 7 that are electrically connected respectively to the first connection pole 3 and to the second connection pole 4 or, where applicable, to the third connection pole 40 of the primary functional module 2 in order to supply power to the additional functional module 5 and, where applicable, the additional functional module 5 comprises a sixth connection pole 70 electrically connected to the second connection pole 4 of the primary functional module 2 (FIGS. 2A to 2G, 3B, 5 and 6),
a reception module 8 comprising at least a first reception area 9 for receiving the primary functional module 2 (FIGS. 3A to 4).

According to the invention, the electrical apparatus 1 is characterized in that the reception module comprises a second reception area 9′ for receiving the additional functional module 5 (FIG. 3A),

and in that said at least one function of the additional functional module 5 is a function of shaping the physical parameters of an electrical signal coming from the first line L of the electrical grid.

Advantageously, the electrical apparatus 1 makes it possible to perform, in addition to the function of interrupting the basic current performed by the primary functional module 2, at least one additional function using the additional functional module 5. Such an additional functional module 5 thus allows the electrical apparatus 1 to be customized. Furthermore, as the additional functional module 5 is optional, it is able to be installed or removed at any time without impacting the electrical installation. Specifically, the electrical apparatus 1 is able to operate only with the primary functional module 2. The electrical apparatus 1 that is obtained is thus particularly flexible. Moreover, the additional function of the additional functional module 5 is not intended to inform the user about the location or the state of the interruption function, but advantageously extends to functions independent of the interruption function.

More particularly, the electrical apparatus 1 according to the invention is intended to form part of an electrical installation (FIGS. 5 and 6) and to be electrically connected to a load 20.

A load 20 is understood to mean an electrical device forming part of the electrical installation, such as a light or a motor or a fan or an electric shutter or a strike plate or a heating and/or air-conditioning element or a transformer.

The load 20 may be a resistive, capacitive or inductive element.

Advantageously, according to the invention, the additional functional module 5 may be electrically connected to the load 20. In these conditions, the additional functional module 5 makes it possible to shape the physical parameters of the electrical signal coming from the first line L of the electrical grid in order to obtain an electrical output signal from the additional functional module 5, which is of a different type and may be transmitted in the second line L1 of the electrical circuit of the electrical installation that is able to be connected to the load 20. Therefore, this electrical output signal shaped by the additional functional module 5 is able to travel through the second electrical line L1 of the electrical circuit of the electrical installation in order to supply power to the load 20, in particular when the control member 2′ is in the open position (open circuit) (FIGS. 5 and 6).

The electrical apparatus 1 is preferably intended to be assembled with or recessed into a support (not shown), such as a wall.

The primary functional module 2 may be a monostable switch module (not shown) or a bistable switch module (FIGS. 1A to 1C). In the case of a monostable switch module, in the open position, the control member 2′ does not act on the opening of the electrical circuit and, in the closed position, the control member 2′ may be designed to close the electrical circuit; in this configuration, the monostable switch module is also called “normally open”. According to one alternative of a monostable switch module, in the open position, the control member 2′ may be designed to open the electrical circuit and, in the closed position, the control member 2′ does not act on the closure of the electrical circuit; in this configuration, the monostable switch module is also called “normally closed”. The control member 2′ of a monostable switch module may preferably be a pushbutton (not shown).

For a bistable switch module, shown in FIGS. 1A to 1C, in the open position, the control member 2′ may be designed to open the electrical circuit and, in the closed position, the control member 2′ may be designed to close the electrical circuit. In this case, the control member 2′ may preferably be a toggle switch that is able to adopt two positions. However, this example is not limiting.

The primary functional module 2 may comprise a first connection pole 3 able and intended to be connected to a first line L of the electrical grid and a second connection pole 4 able and intended to be connected to a second line L1 of the electrical circuit of the electrical installation. In this case, the fourth connection pole 6 and the fifth connection pole 7 are electrically connected respectively to the first connection pole 3 and to the second connection pole 4 (FIG. 5). This configuration makes it possible firstly to supply power to the additional functional module 5 via the electrical grid when the control member 2′ is in the open position (open circuit), and secondly to allow the electrical output signal, coming from the additional functional module 5, to travel through the second electrical line L1 of the electrical circuit of the electrical installation in order to supply power to the load 20.

According to one alternative variant, the primary functional module 2 may comprise a first connection pole 3 able and intended to be connected to a first line L of the electrical grid, a second connection pole 4 able and intended to be connected to a second line L1 of the electrical circuit of the electrical installation and a third connection pole 40 able and intended to be connected to a third neutral line N of the electrical grid (FIG. 6). In this case, the fourth connection pole 6 and the fifth connection pole 7 are electrically connected respectively to the first connection pole 3 and to the third connection pole 40 of the primary functional module 2 in order to supply power to the additional functional module 5. Furthermore, the sixth connection pole 70 of the additional functional module 5 is electrically connected to the second connection pole of the primary functional module 2 so as to allow the electrical output signal coming from the additional functional module 5 to travel through the second electrical line L1 in order to supply power to the load 20.

The first line L may be a power supply line connected to the electrical grid, preferably via a switching device, such as a circuit breaker. The second line L1 may be a return line of the electrical circuit for supplying power to the load 20 of the electrical installation (FIGS. 5 and 6).

The first line L, the second line L1 and the third neutral line N may take the form of one or more cables (not shown).

The electrical installation may preferably be a domestic electrical installation.

The function of the additional functional module 5 may be able and intended to be supplied with power and activated when the control member 2′ of the primary functional module 2 is in the open position.

Advantageously, when the fourth connection pole 6 and the fifth connection pole 7 of the additional functional module 5 are electrically connected respectively to the first connection pole 3 and to the second connection pole 4 of the primary functional module 2 (FIG. 5), the additional functional module 5 is connected in parallel with the electrical circuit between the first connection pole 3 and the second connection pole 4 of the primary functional module 2. The means for performing the function of the additional functional module 5 are able to be supplied with power by the electrical grid when the electrical circuit of the primary functional module 2 is open, and therefore when the control member 2′ is in the open position. As a result, when the control member 2′ is in the open position, the function of the additional functional module 5 is able to be supplied with power. Therefore, only the electrical output signal shaped by the additional functional module 5 is able to travel through the second electrical line L1 in order to supply power to the load 20. By contrast, when the control member 2′ is in the closed position, the function of the additional functional module 5 is short-circuited and is therefore not supplied with power. Therefore, the electrical signal coming from the first line L of the electrical grid is able to travel through the second electrical line L1 in order to supply power to the load 20.

Advantageously, when the fourth connection pole 6 and the fifth connection pole 7 are electrically connected respectively to the first connection pole 3 and to the third connection pole 40, and when the sixth connection pole 70 is electrically connected to the second connection pole 4, the function of the additional functional module 5 is able to be supplied with power by the electrical grid when the electrical circuit of the primary functional module 2 is open and therefore when the control member 2′ is in the open position or when the electrical circuit of the primary functional module 2 is closed and therefore when the control member 2′ is in the closed position. As a result, when the control member 2′ is in the open position or in the closed position, the function of the additional functional module 5 is able to be supplied with power. Therefore, the power supply of the additional functional module 5 is independent of the state of the primary functional module 2. However, in order that only the electrical output signal shaped by the additional functional module 5 is able to travel through the second electrical line L1 in order to supply power to the load 20, the control member 2′ has to be in the open position (open circuit).

In any case, the additional functional module 5 may comprise an electrical energy storage and/or production element and the function of the additional functional module 5 may be able and intended to be supplied with power by said electrical energy storage and/or production element.

Advantageously, the function of the additional functional module 5 is able to be supplied with power by an electrical energy storage and/or production element, which may be made independent and autonomous in relation to the electrical grid. As a result, the function of the additional functional module 5 is able to be supplied with power independently of the open or closed position of the primary functional module 2. For example, when the control member 2′ is in the closed position, the function of the additional functional module 5 is no longer short-circuited and is therefore able to be supplied with power by the electrical energy storage and/or production element and be activated.

The electrical energy storage and/or production element may be a battery, a capacitor, a piezoelectric generator, a photovoltaic generator, or a thermoelectric generator, for example a Peltier or Seebeck generator.

The additional functional module 5 may comprise at least electrical signal processing means able and intended to perform said function of shaping the physical parameters of the electrical signal.

The processing means may be able and intended to modify the shape of the electrical signal, to vary the voltage of the electrical signal and/or the intensity of the current of the electrical signal, to vary the power of the electrical signal, or to vary the frequency of the electrical signal.

The processing means may be chosen from among: a variable speed drive, a relay, a filter, a switch, or a semiconductor transistor, preferably a MOSFET transistor.

The processing means may be able and intended to be actuated locally or remotely by control means.

The control means may in this case consist of a control unit, of smartphone or remote control type, remote from the electrical apparatus 1 and not forming part of the electrical installation. For example, a wireless link, via electromagnetic wave transmission and/or reception means that are described below, may make it possible to establish communication between the control unit and the processing means. According to one alternative variant, the processing means may be actuated via a control button, remote from the electrical apparatus 1 and forming part of the electrical installation. In this case, the link between the control button and the processing means may be wired or wireless.

The additional functional module 5 may comprise at least electromagnetic wave transmission and/or reception means.

These electromagnetic wave transmission and/or reception means may be a radiofrequency communication element, for example Wi-Fi or Bluetooth, or a repeater. Of course, these examples are not limiting.

Advantageously, these electromagnetic wave transmission and/or reception means make it possible to receive and/or transmit data that may in particular relate to the additional functional module 5. Such electromagnetic wave transmission and/or reception means may, in addition, establish a wireless communication link with a control unit, such as a computer, a smartphone or a digital tablet or to another additional functional module 5 according to the invention and that would also be equipped with electromagnetic wave transmission and/or reception means. It is thus possible to interact remotely with the electrical apparatus 1.

The additional functional module 5 may comprise at least one electronic card 10, 11 comprising the processing means and/or the electromagnetic wave transmission and/or reception means and/or the electrical energy storage and/or production element.

According to one variant embodiment of the invention, a first electronic card 10 may comprise a measurement sensor and/or display means and/or electromagnetic wave reception and/or actuation means and/or a transducer and a second electronic card 11 may comprise the electromagnetic wave transmission and/or reception means and/or data processing means and a third electronic card (not shown) may comprise the electrical energy storage and/or production element and/or the processing means.

The additional functional module 5 may comprise at least the display means able and intended to perform a display function.

Advantageously, these display means make it possible to form a visual interface with a user.

These display means may be a screen.

The additional functional module 5 may comprise at least the actuation means able and intended to perform an actuation function.

The actuation means may be an actuator, for example a relay, a solenoid, a micromotor, a piezoelectric mechanism or, in general, any type of means configured so as to transform an electrical quantity into a mechanical quantity or vice versa.

The additional functional module 5 may comprise at least the data processing means able and intended to perform a data processing function.

The data processing means may be a microcontroller. These data processing means may for example make it possible to process data coming from the measurement sensor.

The additional functional module 5 may comprise at least image-capturing means, for example a camera.

The additional functional module 5 may comprise at least the transducer able and intended to perform a function of transforming a physical signal into an electrical signal or vice versa.

The transducer may be an electroacoustic transducer, such as a speaker or a microphone.

The transducer may be a vibrator or a diffuser.

The first electronic card 10, the second electronic card 11 and the third electronic card may be electrically connected to one another.

The first electronic card 10 may preferably be a removable component of the additional functional module 5.

Advantageously, some functions of the additional functional module 5 may thus be modified simply and easily by replacing the first electronic card 10. It is thus not necessary to replace the entire additional functional module 5.

In particular, the first electronic card 10 may comprise at least first connection means 24 complementary with at least second connection means 25 of the second electronic card 11. Said connection means make it possible to electrically and mechanically connect the first electronic card 10 and the second electronic card 11 in a removable and reversible manner (FIGS. 2A and 2F).

The first connection means 24 and the second connection means 25 may consist of a USB connection, by way of non-limiting example.

The primary functional module 2 may comprise at least a first connection terminal 3′ electrically connected to the first connection pole 3 and a second connection terminal 4′ electrically connected to the second connection pole 4, and the first connection terminal 3′ and the second connection terminal 4′ may form a first outlet 13 (FIG. 1C).

According to one alternative possibility, said primary functional module 2 may comprise at least a first conductive wire connected (not shown) to the first connection pole 3 and a second conductive wire (not shown) connected to the second connection pole 4, the first conductive wire and the second conductive wire being able to be connected to a terminal block (not shown) of the additional functional module 5.

Alternatively, the primary functional module 2 may comprise at least a first connection terminal 3′ electrically connected to the first connection pole 3, a second connection terminal 4′ electrically connected to the second connection pole 4 and a third connection terminal 40′ electrically connected to the third connection pole 40, and the first connection terminal 3′, the second connection terminal 4′ and the third connection terminal 40′ may form a first outlet 13′.

According to one alternative possibility, said primary functional module 2 may comprise at least a first conductive wire connected (not shown) to the first connection pole 3, a second conductive wire (not shown) connected to the second connection pole 4, and a third conductive wire (not shown) connected to the third connection pole 40, the first conductive wire, the second conductive wire and the third conductive wire being able to be connected to a terminal block (not shown) of the additional functional module 5.

The additional functional module 5 may comprise at least a fourth connection terminal 6′ electrically connected to the fourth connection pole 6 and a fifth connection terminal 7′ electrically connected to the fifth connection pole 7, and the fourth connection terminal 6′ and the fifth connection terminal 7′ may form a second outlet 14 (FIGS. 2B and 2C).

According to one alternative possibility, said additional functional module 5 may comprise a terminal block (not shown) electrically connected to the fourth connection pole 6 and to the fifth connection pole 7. The first conductive wire and the second conductive wire of the primary functional module 2 may be connected to the terminal block.

Alternatively, the additional functional module 5 may comprise at least a fourth connection terminal 6′ electrically connected to the fourth connection pole 6, a fifth connection terminal 7′ electrically connected to the fifth connection pole 7 and a sixth connection terminal 70′ electrically connected to the sixth connection pole 70, and the fourth connection terminal 6′, the fifth connection terminal 7′ and the sixth connection terminal 70′ may form a second outlet 140 (FIGS. 2D and 2E).

According to one alternative possibility, said additional functional module 5 may comprise a terminal block (not shown) electrically connected to the fourth connection pole 6, to the fifth connection pole 7 and to the sixth connection pole 70. The first conductive wire, the second conductive wire and the third conductive wire of the primary functional module 2 may be connected to the terminal block.

The first outlet 13, 13′ of the primary functional module 2 and the second outlet 14, 140 of the additional functional module 5 may have complementary shapes so as to be connected and so as to electrically and mechanically connect the first connection terminal 3′ to the fourth connection terminal 6′ and so as to electrically and mechanically connect the second connection terminal 4′ to the fifth connection terminal 7′ (FIGS. 1C, 2B, 2C, 3B, 5).

Alternatively, the first outlet 13, 13′ of the primary functional module 2 and the second outlet 14, 140 of the additional functional module 5 may have complementary shapes so as to be connected and so as to electrically and mechanically connect the first connection terminal 3′ to the fourth connection terminal 6′ and so as to electrically and mechanically connect the third connection terminal 40′ to the fifth connection terminal 7′ and so as to electrically and mechanically connect the second connection terminal 4′ to the sixth connection terminal 70′ (FIGS. 1C, 2D, 2E, 3B, 6).

The first connection terminal 3′ and the second connection terminal 4′ or, where applicable, the third connection terminal 40′ may be respectively a first female terminal and a second female terminal, for example taking the form of a cavity provided with electrical contact. In this case, the first outlet 13, 13′ is a socket. This first outlet 13, 13′ may preferably comprise two cavities distributed along one side of a square (FIG. 1C) or three cavities distributed along two sides of a square (FIG. 1C).

The first socket outlet 13, 13′ may preferably have a protection rating whose degree of protection against solids is between 0 and 6 and whose degree of protection against liquids is between 0 and 8. For example, the protection rating may be equal to IP2X, X being a value between 0 and 8.

The fourth connection terminal 6′ and the fifth connection terminal 7′ and, where applicable, the sixth connection terminal 70′ may be respectively a fourth male terminal and a fifth male terminal and, where applicable, a sixth male terminal, for example taking the form of a rod. In this case, the second outlet 14, 140 is a plug. The second outlet 14, 140 may comprise a base 14′ from which the fourth connection terminal 6′ and the fifth connection terminal 7′ and, where applicable, the sixth connection terminal 70′ in the form of a rod extend. The base 14′ preferably has a substantially square shape with rounded corners from which four pads 14″ extending substantially orthogonal to the base 14′ extend. These pads 14″ form a mechanical joint with the first socket outlet 13, 13′, these pads 14″ being able to fit into the cavities. Two of these pads 14″ may support the two rods forming the fourth connection terminal 6′ and the fifth connection terminal 7′ (FIGS. 2A, 2B, 2C, 2G) or three of these pads 14″ may support the three rods forming the fourth connection terminal 6′, the fifth connection terminal 7′ and the sixth connection terminal 70′ (FIGS. 2A, 2D, 2E, 2G).

The primary functional module 2 may comprise a first housing 15 with which the first outlet 13, 13′ and the control member 2′ are assembled (FIGS. 1A, 1B, 1C).

The first housing 15 makes it possible to protect the primary functional module 2.

The first housing 15 may be made from polymer material.

The first housing 15 may comprise four lateral faces 15a, 15b, 15d, a front opening 15e, and a rear face 15f. The first housing 15 may have a substantially rectangular cross section.

The first outlet 13, 13′ and the control member 2′ preferably cover the front opening 15e. As a result, the first outlet 13, 13′ is advantageously accessible from the front of the primary functional module 2, thereby facilitating interlocking with the second outlet 14, 140 of the additional functional module 5.

The additional functional module 5 may comprise a second housing 16 in which said at least one electronic card 10, 11 comprising the measurement sensor and/or the electromagnetic wave transmission and/or reception means and/or the display means and/or the actuation means and/or the data processing means and/or the transducer and/or the processing means and/or the electrical energy storage and/or production element is housed.

The second housing 16 makes it possible to protect the additional functional module 5 (FIGS. 2A and 2B).

The second outlet 14, 140 of the additional functional module 5 may project from the second housing 16 of the additional functional module 5.

The second housing 16 may be made from polymer material.

The second housing 16 may comprise four lateral faces 16a, 16b, 16d, a front opening 16e, and a rear face 16f. The second housing 16 may have a substantially rectangular cross section.

Preferably, the base 14′ of the second outlet 14, 140 may extend in the plane of the front opening 16e and the pads 14″ may extend in the direction of the lateral faces 16a, 16b, 16d.

The second housing 16, the base 14′ and the pads 14″ may form a single one-piece component, which is for example molded.

Alternatively, the second outlet 14 may be a removable element (not shown) of the second housing 16. More particularly, the base 14′ may be mechanically connected to the second housing 16 removably and reversibly by mechanical connection means (not shown). The base 14′ may furthermore comprise electrical connection means (not shown) electrically connected to the fourth connection terminal 6′, to the fifth connection terminal 7′, and where applicable to the sixth connection terminal 70′ and complementary with electrical connection means (not shown) arranged on the second housing 16. These electrical connection means of the second housing 16 may consist of a terminal block.

One of the lateral faces 15b of the first housing 15 may be adjacent to one of the lateral faces 16d of the second housing 16, more particularly these lateral faces 15b, 16d may be contiguous and facing one another. These contiguous lateral faces 15b, 16d may comprise guide means (not shown) in order to facilitate the positioning of the first and second housings 15, 16 with respect to one another.

The first electronic card 10 may cover the front opening 16e.

Advantageously, due to this configuration, the first electronic card 10 is easily accessible and may easily be secured/detached to/from the second electronic card 11 in order to be replaced.

The reception module 8 may comprise a support frame 8′ comprising a central opening 17 at least partly forming said first and second reception areas 9, 9′ receiving the first housing 15 (FIGS. 3A, 3B, 3D) and the second housing 16, and the first housing 15 and the second housing 16 may respectively comprise removable fastening means 18, 19 interacting with the support frame 8′ (FIGS. 1A, 1B, 2A, 2B).

The fastening means 18, 19 respectively of the first housing 15 and of the second housing 16 may preferably consist of two tabs projecting respectively from two of the opposing lateral faces 15a; 16a (FIGS. 1A, 1B, 1C, 2A, 2B, 2D).

The reception module 8 may also comprise a recessed housing 8″ to which the support frame 8′ is able to be fastened by fastening means (not shown) (FIGS. 3A, 3B, 3D, 4). This recessed housing 8″ may be intended to be recessed into a support, such as a wall.

The recessed housing 8″ may comprise a receptacle for receiving the four lateral faces 15a, 15b, 15d and the rear face 15f of the first housing 15 and the four lateral faces 16a, 16b, 16d and the rear face 16f of the second housing 16.

The control member 2′, the base 14′ of the second outlet 14, 140 and the first electronic card 10 may be covered with at least one cover plate 21, which may force the control member into the open position and block access to the control member, which is no longer able to be actuated in this case (FIGS. 3C, 3D, 4).

The cover plate 21 simultaneously plays the role of an interface with the user and may also have an esthetic function and a protective function.

The support frame 8′ may be covered with a covering frame 22.

The additional functional module 5 is suitable and intended for an electrical apparatus 1 as described above, said electrical apparatus comprising a primary functional module 2 and an additional functional module 5.

According to the invention, said additional functional module 5 is characterized in that it corresponds to the additional functional module 5 of said electrical apparatus 1 and comprises at least a fourth connection pole 6 and a fifth connection pole 7 that are able and intended to be electrically connected respectively to the first connection pole 3 and to the second connection pole 4 or, where applicable, to the third connection pole 40 of the primary functional module 2 of the electrical apparatus 1, in order to supply power to the additional functional module 5 and, where applicable, the additional functional module 5 comprises a sixth connection pole 70 able and intended to be electrically connected to the second connection pole 4 of the primary functional module 2, and comprises means for performing at least one function requiring an electric power supply, and in that said at least one function of the additional functional module 5 is a function of shaping the physical parameters of an electrical signal coming from the first line L of the electrical grid.

The function of the additional functional module 5 may be able and intended to be supplied with power and activated when the control member 2′ of the primary functional module 2 is in the open position, as explained above.

The additional functional module 5 may comprise an electrical energy storage and/or production element and the function of the additional functional module 5 may be able and intended to be supplied with power by said electrical energy storage and/or production element.

Said electrical energy storage and/or production element may be as described above.

The additional functional module 5 may comprise at least electrical signal processing means able and intended to perform said function of shaping the physical parameters of the electrical signal.

The processing means may be able and intended to modify the shape of the electrical signal, to vary the voltage of the electrical signal and/or the intensity of the current of the electrical signal, to vary the power of the electrical signal, or to vary the frequency of the electrical signal.

The processing means may be chosen from among: a variable speed drive, a relay, a filter, a switch, or a semiconductor transistor, preferably a MOSFET transistor.

The processing means may be able and intended to be actuated locally or remotely by control means.

The additional functional module 5 may comprise at least one measurement sensor able and intended to perform a function of measuring at least one physical parameter.

The measurement sensor may be as described above.

The additional functional module 5 may comprise at least electromagnetic wave transmission and/or reception means.

The electromagnetic wave transmission and/or reception means may be as described above.

The additional functional module 5 may comprise at least display means able and intended to perform a display function.

The display means may be as described above.

The additional functional module 5 may comprise at least actuation means able and intended to perform an actuation function.

The actuation means may be as described above.

The additional functional module 5 may comprise at least data processing means able and intended to perform a data processing function.

The processing means may be as described above.

The additional functional module 5 may comprise at least image-capturing means, for example a camera.

The additional functional module 5 may comprise at least one transducer able and intended to perform a function of transforming a physical signal into an electrical signal or vice versa, as described above.

The additional functional module 5 may comprise at least one electronic card 10, 11 comprising the processing means and/or the electromagnetic wave transmission and/or reception means and/or the electrical energy storage and/or production element.

The additional functional module 5 may comprise a second housing 16 in which said at least one electronic card 10, 11 comprising the processing means and/or the electromagnetic wave transmission and/or reception means and/or the electrical energy storage and/or production element is housed.

The additional functional module 5 may comprise a first electronic card 10, a second electronic card 11 and a third electronic card, as described above.

The second housing 16 may be as described above.

The additional functional module 5 may comprise at least a fourth connection terminal 6′ electrically connected to the fourth connection pole 6 and a fifth connection terminal 7′ electrically connected to the fifth connection pole 7, and the fourth connection terminal 6′ and the fifth connection terminal 7′ may form a second outlet 14.

According to one alternative possibility, said additional functional module 5 may comprise a terminal block (not shown) electrically connected to the fourth connection pole 6 and to the fifth connection pole 7. The first conductive wire and the second conductive wire of the primary functional module 2 may be connected to the terminal block.

Alternatively, the additional functional module 5 may comprise at least a fourth connection terminal 6′ electrically connected to the fourth connection pole 6, a fifth connection terminal 7′ electrically connected to the fifth connection pole 7 and a sixth connection terminal 70′ electrically connected to the sixth connection pole 70, and the fourth connection terminal 6′, the fifth connection terminal 7′ and the sixth connection terminal 70′ may form a second outlet 140.

According to one alternative possibility, said additional functional module 5 may comprise a terminal block (not shown) electrically connected to the fourth connection pole 6, to the fifth connection pole 7 and to the sixth connection pole 70. The first conductive wire, the second conductive wire and the third conductive wire of the primary functional module 2 may be connected to the terminal block.

The second outlet 14, 140 of the additional functional module 5 may project from the second housing 16 of the additional functional module 5.

The second outlet 14, 140 may be as described above.

The second housing 16 may comprise removable fastening means 18, 19 able and intended to interact with a support frame 8′ of the electrical apparatus 1. These fastening means 18, 19 may be as described above.

The invention also relates to an electrical installation able and intended to be connected to the electrical grid comprising at least one load 20.

According to the invention, the electrical installation is characterized in that it comprises at least one electrical apparatus as described above.

Of course, the invention is not limited to the embodiments that are described and shown in the appended drawings. Modifications remain possible, particularly from the point of view of the composition of the various elements or by substituting technical equivalents, without otherwise departing from the scope of protection of the invention.

1. An electrical apparatus for an electrical installation, able to be connected to an electrical grid, comprising at least:
a primary functional module comprising a first connection pole able to be connected to a first line of the electrical grid and a second connection pole able to be connected to a second line of the electrical circuit of the electrical installation and, where applicable, a third connection pole able to be connected to a third neutral line of the electrical grid,
the primary functional module being able to perform a function of interrupting the current between the first connection pole and the second connection pole and comprises a control member such that, in an open position, an electrical circuit between the first connection pole and the second connection pole is open and that, in a closed position, the electrical circuit is closed,
an additional functional module comprising means for performing at least one function requiring an electric power supply, comprising at least a fourth connection pole and a fifth connection pole that are electrically connected respectively to the first connection pole and to the second connection pole or, where applicable, to the third connection pole of the primary functional module in order to supply power to the additional functional module and, where applicable, the additional functional module comprises a sixth connection pole electrically connected to the second connection pole of the primary functional module,
a reception module comprising at least a first reception area for receiving the primary functional module,
wherein the reception module comprises a second reception area for receiving the additional functional module, and in that said at least one function of the additional functional module is a function of shaping the physical parameters of an electrical signal coming from the first line of the electrical grid.

2. The electrical apparatus as claimed in claim 1, wherein the function of the additional functional module is able and intended to be supplied with power and activated when the control member of the primary functional module is in the open position.

3. The electrical apparatus as claimed in claim 1, wherein the additional functional module comprises an electrical energy storage and/or production element and in that the function of the additional functional module is able to be supplied with power by said electrical energy storage and/or production element.

4. The electrical apparatus as claimed in claim 1, wherein the additional functional module comprises at least electrical signal processing means able to perform said function of shaping the physical parameters of the electrical signal.

5. The electrical apparatus as claimed in claim 4, wherein the processing means are able to modify the shape of the electrical signal, to vary the voltage of the electrical signal and/or the intensity of the current of the electrical signal, to vary the power of the electrical signal, or to vary the frequency of the electrical signal.

6. The electrical apparatus as claimed in claim 5, wherein the processing means are chosen from among: a variable speed drive, a relay, a filter, a switch, a semiconductor transistor, or a MOSFET transistor.

7. The electrical apparatus as claimed in claim 4, wherein the processing means are able to be actuated locally or remotely by control means.

8. The electrical apparatus as claimed in any one of claims 1 to 7, characterized in that the additional functional module comprises at least electromagnetic wave transmission and/or reception means.

9. The electrical apparatus as claimed in claim 4, wherein the additional functional module comprises at least one electronic card comprising the processing means and/or the electromagnetic wave transmission and/or reception means and/or the electrical energy storage and/or production element.

10. The electrical apparatus as claimed in claim 1, wherein the primary functional module comprises at least a first connection terminal electrically connected to the first connection pole and a second connection terminal electrically connected to the second connection pole, and in that the first connection terminal and the second connection terminal form a first outlet, or the primary functional module comprises at least a first connection terminal electrically connected to the first connection pole, a second connection terminal electrically connected to the second connection pole and a third connection terminal electrically connected to the third connection pole, and the first connection terminal, the second connection terminal and the third connection terminal form a first outlet.

11. The electrical apparatus as claimed in claim 1, wherein the additional functional module comprises at least a fourth connection terminal electrically connected to the fourth connection pole and a fifth connection terminal electrically connected to the fifth connection pole and, where applicable, a sixth connection terminal electrically connected to the sixth connection pole, and in that the fourth connection terminal and the fifth connection terminal form a second outlet or the fourth connection terminal, the fifth connection terminal and the sixth connection terminal form a second outlet.

12. The electrical apparatus as claimed in claim 11, wherein the first outlet of the primary functional module and the second outlet of the additional functional module have complementary shapes so as to be connected and so as to electrically and mechanically connect the first connection terminal to the fourth connection terminal and so as to electrically and mechanically connect the second connection terminal to the fifth connection terminal or, where applicable, so as to electrically and mechanically connect the third connection terminal to the fifth connection terminal and, where applicable, so as to electrically and mechanically connect the second connection terminal to the sixth connection terminal.

13. The electrical apparatus as claimed in claim 10, wherein the primary functional module comprises a first housing with which the first outlet and the control member are assembled.

14. The electrical apparatus as claimed in claim 9, wherein the additional functional module comprises a second housing in which said at least one electronic card comprising the processing means and/or the electromagnetic wave transmission and/or reception means and/or the electrical energy storage and/or production element is housed.

15. The electrical apparatus as claimed in claim 14, wherein the second outlet of the additional functional module projects from the second housing of the additional functional module.

16. The electrical apparatus as claimed in claim 13, wherein the reception module may comprise a support frame comprising a central opening at least partly forming said first and second reception areas receiving the first housing and the second housing, and in that the first housing and the second housing respectively comprise removable fastening means interacting with the support frame.

17. An additional functional module for an electrical apparatus as claimed in claim 1, said electrical apparatus comprising a primary functional module and an additional functional module, wherein said additional functional module corresponds to the additional functional module of said electrical apparatus and comprises at least a fourth connection pole and a fifth connection pole able and intended to be electrically connected respectively to the first connection pole and to the second connection pole or, where applicable, to the third connection pole of the primary functional module of the electrical apparatus, in order to supply power to the additional functional module and, where applicable, the additional functional module comprises a sixth connection pole able and intended to be electrically connected to the second connection pole of the primary functional module, and comprises means for performing at least one function requiring an electric power supply, and in that said at least one function of the additional functional module is a function of shaping the physical parameters of an electrical signal coming from the first line of the electrical grid.

18. The module as claimed in claim 17, wherein the function of the additional functional module is able to be supplied with power and activated when the control member of the primary functional module is in the open position.

19. The module as claimed in claim 17, wherein said module characterized in that it comprises an electrical energy storage and/or production element and in that the function of the additional functional module is able and intended to be supplied with power by said electrical energy storage and/or production element.

20. The module as claimed in claim 17, characterized in that it wherein said module comprises at least electrical signal processing means able to perform said function of shaping the physical parameters of the electrical signal.

21. The module as claimed in claim 20, wherein the processing means are able to modify the shape of the electrical signal, to vary the voltage of the electrical signal and/or the intensity of the current of the electrical signal, to vary the power of the electrical signal, or to vary the frequency of the electrical signal.

22. The module as claimed in claim 21, wherein the processing means are chosen from among: a variable speed drive, a relay, a filter, a switch, a semiconductor transistor, or a MOSFET transistor.

23. The electrical apparatus as claimed in claim 20, wherein the processing means are able to be actuated locally or remotely by control means.

24. The module as claimed in claim 17, wherein said module comprises at least electromagnetic wave transmission and/or reception means.

25. The module as claimed in claim 20, wherein said module comprises at least one electronic card comprising the processing means and/or the electromagnetic wave transmission and/or reception means and/or the electrical energy storage and/or production element.

26. The module as claimed in claim 25, wherein a first electronic card comprises a measurement sensor and/or display means and/or a transducer and in that a second electronic card comprises the electromagnetic wave transmission and/or reception means and/or data processing means and in that a third electronic card comprises the electrical energy storage and/or production element and/or the processing means.

27. The module as claimed in claim 26, wherein the first electronic card is a removable component of said additional functional module.

28. The module as claimed in claim 27, wherein the first electronic card comprises at least first connection means complementary with at least second connection means of the second electronic card.

29. The module as claimed in claim 25, wherein said module comprises a second housing in which said at least one electronic card comprising the processing means and/or the electromagnetic wave transmission and/or reception means and/or the electrical energy storage and/or production element is housed.

30. The module as claimed in claim 17, wherein said module comprises at least a fourth connection terminal connected to the fourth connection pole and a fifth connection terminal connected to the fifth connection pole and, where applicable, a sixth connection terminal electrically connected to the sixth connection pole, and in that the fourth connection terminal and the fifth connection terminal form a second outlet or the fourth connection terminal, the fifth connection terminal and the sixth connection terminal form a second outlet.

31. The module as claimed in claim 29, wherein the second outlet of the additional functional module projects from the second housing of the additional functional module.

32. The module as claimed in claim 29, wherein the second housing comprises removable fastening means able to interact with a support frame of the electrical apparatus.

33. An electrical installation able to be connected to the electrical grid comprising at least one load, wherein said electrical installation comprises at least one electrical apparatus as claimed in claim 1.
